(19) United States
(12) Patent Application Publication
(10) Pub. No.: US 2018/0280989 A1
(43) Pub. Date: Oct. 4, 2018

(54) GRINDING ADDITIVE FOR CARBONACEOUS SOLID

(71) Applicant: Construction Research & Technology, GmbH, Trostberg (DE)

(72) Inventors: Attilio CAMPLONE, Pescara (IT); Roberta MARGAROTTO, Ponzano Veneto (IT)

(21) Appl. No.: 15/769,885

(22) PCT Filed: Oct. 26, 2016
(86) PCT No.: PCT/EP2016/075713

§ 371 Date: Apr. 20, 2018

(30) Foreign Application Priority Data
Oct. 27, 2015 (EP) 15191686.3

(51) Int. Cl. B02C 23/06; C04B 7/44; C10L 5/04

(52) U.S. Cl. CPC B02C 23/06; C10L 2290/28; C10L 5/04; C04B 7/4407

(57) ABSTRACT

The invention relates to a method for grinding a carbonaceous solid, wherein a grinding additive is added before or during grinding, and the grinding additive, based on the dry mass, comprises 6% to 80% by weight of caprolactam and 1.5% to 30% by weight of aminocaproic acid, where, based in each case on the dry mass, 0.002% to 2% by weight of the grinding additive is used, based on the total amount of carbonaceous solid. Further claimed are a grinding additive and the use of a grinding additive for reducing the energy employed for a given grinding outcome and also for reducing the agglomeration tendency of the resultant product.

The invention relates to a method for grinding a carbonaceous solid, to a grinding additive and to the use thereof.

Grinding additives act by enveloping the particles that have a tendency towards agglomeration with thin layers, more particularly monomolecular layers, and thus lead to neutralization of the surface charges. Viewed physically, the grinding additives rapidly provide charge carriers which are available for satisfying the charges which come about on the fracture surfaces during fracture of the particles, and so reduce the tendency towards agglomeration. In addition, grinding additives are absorbed on the fracture surfaces of the grains prior to separation, and prevent them from reuniting.

In practice, a suitable grinding additive is selected by aiming to optimize the following parameters in particular: preventing caking in the grinding assembly, obtaining the maximum fineness of grind or maximum specific surface area of the grind stock, improving the fluidity of the grind stock, homogenizing the grind stock, disrupting agglomerates of the grind stock, and reducing the costs of the grinding operation.

Petroleum coke (petcoke) is a carbonaceous solid derived from oil refinery coker units or other cracking processes. It is a by-product from oil refineries and is mainly composed of carbon. Fuel grade petcoke also contains high levels of sulphur. There has been considerable interest in petcoke for many years, as it is normally cheaper than coal and has a very high calorific value. There are three types of petcoke, which are been produced depending on the process of production. There exist delayed, fluid and flexi coking with delayed coking constituting over 90% of the total production. All three types of petcoke have higher calorific values than coal and contain less volatile matter and ash.

The main uses of petcoke are as energy source for cement production, power generation and iron and steel production. There are many constraints for effective utilization of petcoke as a fuel in cement industry. One of these constraints is the hardness of petcoke, its hardness is greater than coal and hence the power consumption of the grinding systems is increased. Due to its low content of volatile matter, petcoke has poor ignition and burnout characteristics. Therefore, petcoke has to be ground to a much higher fineness than conventional fuels in order to allow its use as fuel in cement kilns or calciners.

However, carbonaceous solids, especially petcoke are difficult to grind, primarily because of their high carbon content that has a lubricating effect, so that carbonaceous solids shows a lesser tendency towards comminution by attrition and abrasion in the grinding systems.

U.S. Pat. No. 4,162,044 discloses a process for grinding of coal or ores in a liquid, medium with use of a grinding aid comprising an anionic polyelectrolyte derived from polyacrylic acid in order to increase the grinding efficiency.

U.S. Pat. No. 4,136,830 discloses a process for grinding coal or ores containing metal values comprising carrying out said grinding in a liquid medium and with a grinding aid comprising copolymers or salts of copolymers of styrene with maleic anhydride, in order to increase the grinding efficiency.

WO 2015107408 discloses a method of enhancing the dry grinding efficiency of petcoke comprising adding additives to the petcoke and dry grinding the petcoke together with the additives, a combination of at least one organic additive and at least one inorganic additive is used as said additives.

Therefore, it is an object of the present invention to improve the dry grinding efficiency of carbonaceous solids. In particular, the invention aims at reducing the energy consumption for grinding carbonaceous solids to a given fineness, to enhance the grinding fineness with the same energy consumption and to improve the particle size distribution, lowering coarse fractions. In case of pulverized fuels is important to reduce the coarser fractions that are the cause of poor burning conditions. It was a further objection of the present invention not to modify the flammability and safety of the carbonaceous solid during grinding, storage and fuel use.

This object has been achieved by a method for grinding a carbonaceous solid, wherein a grinding additive is added before or during grinding,

where the grinding additive, based on the dry mass, comprises

6% to 80% by weight of caprolactam and

1.5% to 30% by weight of aminocaproic acid,

where, based in each case on the dry mass, 0.002% to 2% by weight of the grinding additive is used, based on the total amount of carbonaceous solid.

Carbonaceous solids according to the invention are any carbonaceous solid fuels. Among such carbonaceous solids are included all ranks of coal, lignite, oil shale, tar sands, coke from coal or bituminous pitch, solid tar, petcoke, high reactive solid fuels such as char and lignite. In one preferred embodiment the carbonaceous solid is at least one from the series of coal, coke and petcoke, most preferably petcoke.

Surprisingly it has been found that the products ground with the grinding additive of the invention exhibit a reduced agglomeration tendency, hence having a good pack set, which also impacts positively on grindability. A particular consequence of a very good pack set is that the product produced flow very readily, and this is desirable in the context, for example, of storage in silos.

The grinding additive of the invention may preferably comprise at least one further grinding additive from the series of polycarboxylate ethers, lignosulphonate, melamine-formaldehydesulphonate, naphthalene-formaldehydesulphonate, mono-, di-, tri- and polyglycols, polyalcohols, alkanolamine, amino acids, sugars, molasses, organic and inorganic salts, monocarboxylic acids with 1 to 4 carbon atoms and surfactants.

The grinding additive may more particularly comprise 3% to 70% by weight of at least one alkanolamine or alkanolamine salt. In this context the at least one alkanolamine of the invention may comprise monoethanolamine, diethanolamine, triethanolamine, monoisopropanolamine, diisopropanolamine, triisopropanolamine, diethanolisopropanolamine, ethanoldiisopropanolamine, hydroxyalkyl-substituted ethylene polyamines, hydroxyalkyl-substituted alkyl diamines, more particularly dihydroxyethylethylenediamine, trihydroxyethylethylenediamine, tetrahydroxyethylethylenediamine, dihydroxypropylethylenediamine, trihydroxypropylethylenediamine, tetrahydroxypropylethylenediamine, polyhydroxyalkyl-substituted polyethyleneamine, poly(hydroxyethyl)polyethyleneimine, N,N-bis(2-hydroxyethyl)-2-propanolamine and N,N-bis(2-hydroxypropyl)-N-(hydroxyethyl)amine, N,N,N′,N′-tetra(2-hydroxyethyl)ethylendiamine, N,N,N′,N′-tetra(2-hydroxypropyl)ethylendiamine and methyldiethanolamine. Particularly preferred are triisopropanolamine and triethanolamine. The stated alkanolamines may additionally be present in salt form, more preferably with organic anions, more particularly formate, acetate and propionate.

In one preferred embodiment, the grinding additive may comprise at least one polyethylene glycol ethers or polypropylene glycol ethers or random ethylene oxide/propylene oxide copolymers, preferably in an amount of 3% to 70% by weight, based on the dry mass of the grinding additive. In one specific embodiment, the grinding additive comprises polypropylene glycol ethers having an average molar mass of up to 400 g/mol, preferably in an amount of 3% to 70% by weight, based on the dry mass of the grinding additive.

The grinding additive of the invention may preferably comprise at least one monocarboxylic acid with 1 to 4 carbon atoms, preferably in an amount of 3% to 70% by weight, based on the dry mass of the grinding additive. Particularly preferred the monocarboxylic acid is acetic acid.

The present invention further relates to a grinding additive comprising at least one surfactant, preferably in an amount of 3% to 70% by weight, based on the dry mass of the grinding additive. In one specific embodiment, the grinding additive comprises at least one anionic surfactant. Particularly preferred the surfactant is sodium lauryl ether sulphate.

In one preferred embodiment, based on the dry mass, 0.01% to 0.5% by weight, more particularly 0.01% to 0.2% by weight of the grinding additive of the invention is used, based on the carbonaceous solid. In one specific embodiment, the grinding additive of the invention is applied before grinding to the composition that is to be ground, and grinding then takes place. In principle, however, the grinding additive of the invention can also be added during the grinding operation. Addition before grinding, however, is preferred.

The grinding additive of the invention is applied preferably as an aqueous suspension to the carbonaceous solid. In one preferred embodiment, the grinding additive, based on the dry mass, may comprise 1% to 20% by weight of alkali metal hydroxide, more particularly sodium hydroxide. With further preference, the grinding additive, based on the dry mass, may comprise 1% to 50% by weight of caprolactam oligomers.

Especially suitable as grinding additives of the invention are specific products from the preparation of caprolactam. Specific products of this kind are obtained in the preparation of caprolactam by the cyclohexanone oxime process via hydroxylamine (Hans Jürgen Arpe, Industrielle Organische Chemie, 2007 Wiley-VCD, page 281). As well as caprolactam, these products also contain aminocaproic acid. The product in question is more preferably a product of caprolactam preparation that comprises, based on the dry mass, 6% to 80% by weight of caprolactam, 2% to 20% by weight of oligomers of caprolactam, 1.5% to 30% by weight of aminocaproic acid, 1% to 20% by weight of alkali metal hydroxide, and optionally up to 20% by weight of other organic constituents.

The grinding operation takes place typically in a ball mill or vertical roller mill. It is, however, also possible in principle to use other mills of the kind known within the industry. In one preferred embodiment the grinding is carried out in a vertical roller mill.

The fineness of the carbonaceous solid varies according to the grinding time. The fineness of carbonaceous solid is indicated typically as D50 value. The fineness and the particle size distribution are highly relevant to practice. Such particle size analyses are determined by laser particle granulometry (Mastersizer 2000, Malvern Instruments Ltd). Through the use of the grinding additive according to the invention it is possible to achieve a marked reduction in the grinding time to achieve the desired fineness of the carbonaceous solid. As a result of the thus-reduced energy costs, the use of these grinding additives is of great interest economically.

The present invention further provides for the use of a mixture comprising, based on the dry mass, 6% to 80% by weight of caprolactam and 1.5% to 30% by weight of aminocaproic acid as grinding additive for a carbonaceous solid, where, based in each case on the dry mass, 0.002% to 2% by weight of the grinding additive is used, based on the carbonaceous solid, for reducing the energy employed for a given grinding outcome and also for reducing the agglomeration tendency of the resultant product.

The present invention further relates to a composition comprising, based in each case on the dry mass, a carbonaceous solid and based on the total amount of the carbonaceous solid 0.002% to 2% by weight of a mixture comprising, 6% to 80% by weight of caprolactam and 1.5% to 30% by weight of aminocaproic acid. In one preferred embodiment the composition comprises more than 80% by weight, more particularly more than 90% by weight, most preferably more than 97% by weight of a carbonaceous solid.

The present invention makes available, in particular, grinding additives which exhibit an outstanding effect during the grinding procedure and more particularly lead to a reduction in the energy to be expended for a given grinding outcome. Furthermore, the ground product has a reduced agglomeration tendency, hence exhibiting a good pack set, and this is a great advantage especially in the context of the storage of the product.

The examples which follow illustrate the advantages of the present invention.

### EXAMPLES

General Test Procedure

The grinding tests are carried out in a planetary laboratory ball mill (PM 100, Retsch GmbH). A total weight of 30 g petcoke (table 1) or coal (table 2) is weighed out beforehand on a precision balance and pre-grinded 3 minutes for uniformity without grinding additive in the mill. Based on the weight of petcoke or coal the amount of grinding additive according to table 1 or table 2 is added. Grinding is then carried out for 12 minutes at ambient temperature (25° C.). The resultant petcoke or coal is sieved through a 1 mm sieve in order to remove the grinding beads.

TABLE 1
Petcoke grinding test

| Grinding Additive | A | D | none | water |
|---|---|---|---|---|
| Concentration of | 50% by | 50% by | — | 100% |
| Grinding Additive | weight | weight | | |
| | in water | in water | | |
| Dosage ppm | 900 | 830 | — | 1060 |
| D50 value | 14.75 | 15.02 | 15.29 | 15.61 |

TABLE 2
Coal grinding test

| Grinding Additive | A | B | C |
|---|---|---|---|
| Concentration of | 40% by | 45% by | 50% by |
| Grinding Additive | weight | weight | weight |
| | in water | in water | in water |
| Dosage | 1300 | 800 | 830 |
| D50 value | 14.47 | 15.57 | 15.42 |

The particle size (D50 value) is determined as the average of two measurements by laser particle granulometry (Mastersizer 2000, Malvern Instruments Ltd).

“A”: The inventive grinding additive is a product from preparation of caprolactam, containing 30.2% by weight caprolactam monomer, 14.1% by weight oligomers of caprolactam, 7% by weight aminocaproic acid, 26.6% by weight water, 5.2% by weight NaOH and 11.9% by weight other organic constituents.

“B”: Polycarboxylate ether (Sokalan® CP 45, BASF SE)

“C”: Raw glycerol 80% from bio-diesel production process

“D”: Diethylene glycol 99%, tech grade

All dosages were adapted to get approximately the same active content of the main ingredient.

Coal or petcoke after grinding with inventive grinding additive “A” show the best value of global fineness and particle size distribution compared with other typical grinding additives used for grinding carbonaceous solids.

1. A method for grinding a carbonaceous solid, wherein a grinding additive is added before or during grinding, characterized in that the grinding additive, based on the dry mass, comprises 6% to 80% by weight of caprolactam and 1.5% to 30% by weight of aminocaproic acid, where, based in each case on the dry mass, 0.002% to 2% by weight of the grinding additive is used, based on the total amount of carbonaceous solid.

2. The method according to claim 1, characterized in that the grinding additive comprises at least one further grinding additive selected from the group of polycarboxylate ethers, lignosulphonate, melamine-formaldehydesulphonate, naphthalene-formaldehydesulphonate, mono-glycols, di-glycols, tri-glycols, polyglycols, polyalcohols, alkanolamine, amino acids, sugars, molasses, organic salts, inorganic salts, monocarboxylic acids with 1 to 4 carbon atoms, and surfactants.

3. The method according to claim 1, characterized in that the carbonaceous solid is at least one selected from the group of coal, coke, and petcoke.

4. The method according to claim 1, characterized in that, based in each case on the dry mass, 0.01% to 0.5% by weight of the grinding additive is used, based on the total amount of carbonaceous solid.

5. The method according to claim 1, characterized in that the grinding additive is applied as an aqueous suspension.

6. The method according to claim 1, characterized in that the grinding additive is applied before grinding.

7. The method according to claim 1, characterized in that the grinding additive, based on the dry mass, comprises 1% to 20% by weight of alkali metal hydroxide.

8. The method according to claim 1, characterized in that the grinding additive comprises caprolactam oligomers.

9. The method according to claim 1, characterized in that grinding is carried out in a vertical roller mill.

10. A method comprising adding of a mixture comprising, based on the dry mass, 6% to 80% by weight of caprolactam and 1.5% to 30% by weight of aminocaproic acid as grinding additive for a carbonaceous solid, where, based in each case on the dry mass, 0.002% to 2% by weight of the grinding additive is used, based on the carbonaceous solid, for reducing the energy employed for a given grinding outcome and also for reducing the agglomeration tendency of the resultant product.

11. A composition comprising, based in each case on the dry mass, a carbonaceous solid and based on the total amount of the carbonaceous solid, 0.002% to 2% by weight of a mixture comprising, 6% to 80% by weight of caprolactam and 1.5% to 30% by weight of aminocaproic acid.

12. The composition according to claim 11, characterized in that the composition comprises more than 80% by weight of a carbonaceous solid.

13. The composition according to claim 11, characterized in that the mixture is a grinding additive comprising at least one further grinding additive selected from the group of polycarboxylate ethers, lignosulphonate, melamine-formaldehydesulphonate, naphthalene-formaldehydesulphonate, mono-glycols, di-glycols, tri-glycols, polyglycols, polyalcohols, alkanolamine, amino acids, sugars, molasses, organic salts, inorganic salts, monocarboxylic acids with 1 to 4 carbon atoms, and surfactants.

14. The composition according to claim 11, characterized in that the carbonaceous solid is at least one selected from the group of coal, coke, and petcoke.

15. The composition according to claim 11, characterized in that, based in each case on the dry mass, 0.01% to 0.5% by weight of the mixture is present, based on the total amount of carbonaceous solid.

16. The composition according to claim 11, characterized in that the mixture, based on the dry mass, comprises 1% to 20% by weight of alkali metal hydroxide.

17. The composition according to claim 11, characterized in that the mixture comprises caprolactam oligomers.
